(19) United States
(12) Patent Application Publication
(10) Pub. No.: US 2006/0190110 A1
(43) Pub. Date: Aug. 24, 2006

(54) Computer implemented system for management of vehicle painting operation

(76) Inventors: Sean A. Holt, Mississauga (CA); Philippe D. Henriques, Mississauga (CA)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/267,787

(22) Filed: Nov. 4, 2005

Related U.S. Application Data
(60) Provisional application No. 60/625,558, filed on Nov. 5, 2004.

(51) Int. Cl. G06F 19/00

(52) U.S. Cl. 700/96; 700/283

(57) ABSTRACT

This invention is directed to a computer-implemented system for the management of a vehicle painting operation of a vehicle assembly plant, which comprises
(1) a central computer;
(2) computer implemented materials management system linked to the central computer that comprises for the continuous monitoring of coating materials supplied to paint applications systems for the coating of vehicles or parts thereof or both, continuous monitoring of circulation systems for the paint applications systems, monitoring of paint application systems,
(3) a computer implemented system for monitoring the electrocoating of vehicles linked to the central computer that comprises monitoring the electrocoating tank, the associated deionized water system, the ultrafiltration system, the anolyte system and the rinse system, and the electrocoat baking oven;
(4) a computer implemented system for monitoring the top coating of vehicles after being electrocoated linked to the central computer that comprises monitoring all of the aspects of the primer application, the base coat application and the clear top coat application; and
(5) a computer implemented system for providing additional elements for the management of the vehicle painting operation which comprises safety items and training items;
   wherein the central computer is interactive with computer-implemented systems (1) through (5) to provide for the management of a vehicle painting operation of a vehicle assembly plant by personal.

### CROSS REFERENCE TO RELATED APPLICATION

This application claims the benefit of U.S. Provisional Application 60/625,558, filed Nov. 5, 2004.

### BACKGROUND OF THE INVENTION

This invention relates to a computer-implemented method and system for managing the painting operation of an automotive or truck OEM (original equipment manufacturing) plant.

Description of the Problem

In an automobile or truck manufacturing plant, the painting of the vehicles is a very important step in the manufacturing process and all aspects of the painting operation need to be monitored and controlled by personnel in the plant. For example, the process flow of materials must be monitored and managed. The paint inventory must be monitored and managed so that there is an adequate supply of paint available and the paint supplier is providing the necessary quantities of paint in the desired color and quality. The circulation systems which include mixing tanks, mixing processes, incoming quality verifications for paints and the like, must be continuously monitored and corrections made to bring the systems within operational standards. Spray booths and electrocoating tanks must be monitored and environmental concerns, such as, VOC (volatile organic solvent) usage and reports must be addressed and completed. Costs per vehicle painted need to be calculated and monitored and reported to the vehicle manufacturer and painted vehicles need to be inspected for defects and defects corrected.

One important aspect of a typical vehicle painting process is the electrocoating process wherein the electrocoating tanks and their associated systems, such as, the rinse system, the ultrafiltration system, the anolyte system and the deionized water system need to be constantly monitored and adjusted. The feed rate of paint to the electrocoating tanks and the monitoring of these tanks must occur.

Another very important aspect of the vehicle painting process is the topcoat system, which comprises the primer, pigmented base coat and clear topcoat. This part of the painting process is subject to a wide variety of problems and requires constant monitoring and solutions for problems must be found almost immediately otherwise vehicle manufacturing will be halted. Such problems can range from appearance of the vehicle due to, for example, orange peel appearance, craters, low gloss or DOI (distinctness of image), to failure of the paint, such as, inter-coat adhesion, blistering, poor chip resistance, mud cracking and the like. As defects in the painted finish occur and are noted during the painting process, a solution is determined to correct the defect and it is implemented. These problems and solutions are all entered into a database for a particular plant and are readily available should the problem occur again. However, if the same problem arises at another plant, the database with the solution is likely not available and the problem is solved independently for a second time. Also, there may be improved solutions to the problem but not available on the database. It would be desirable to have a current database with information that is available to all manufacturing plant sites as well as updated test information, updated material supply data and other information that is commonly used by all of the manufacturing plants.

There are additional elements for the management of a vehicle painting operation, such as, safety concerns, safety equipment and procedures, training of personnel, quality control aspects, contacts, for example, of material suppliers, equipment suppliers, service teams and organizations and other useful tools, such as, process layouts, conversion calculations, paint facility overview, equipment lists and the like that should be made available for the management of a vehicle painting operation and should be incorporated into a computer implemented system.

It would be desirable to have an integrated and comprehensive system wherein all information as discussed above would be available in an overall system so that a vehicle painting operation can be adequately and efficiently monitored and managed. The novel computer implemented system of this invention accomplishes the above.

### SUMMARY OF THE INVENTION

This invention is directed to a computer-implemented system for the management of a vehicle painting operation of a vehicle assembly plant, which comprises
(1) a central computer;
(2) computer implemented materials management system linked to the central computer that comprises for the continuous monitoring of coating materials supplied to paint applications systems for the coating of vehicles or parts thereof or both, continuous monitoring of circulation systems for the paint applications systems, monitoring of paint application systems, and optionally, monitoring and reporting environmental matters, inventory monitoring of coating materials in the assembly plant, a feed back system to the supplier of coating materials for manufacturing, quality control and supply to the plant, method of calculating per unit costs of vehicle painting and monitoring of finished painted vehicles with feed back to calculating per unit costs also can be accomplished;
(3) a computer implemented system for monitoring the electrocoating of vehicles linked to the central computer that comprises monitoring the electrocoating tank, the associated deionized water system, the ultrafiltration system, the anolyte system and the rinse system, and the electrocoat baking oven;
(4) a computer implemented system for monitoring the top coating of vehicles after being electrocoated linked to the central computer that comprises monitoring all of the aspects of the primer application, the base coat application and the clear top coat application; and
(5) a computer implemented system for providing additional elements for the management of the vehicle painting operation which comprises safety items, such as, protective equipment, safety programs for workers, and material data sheets; training items, such as, field guides, tracking employee training records, employee training matrix and operational procedures, and optionally, other elements, such as, supplier and customer contacts, quality policies and guidelines, and other items for the management of a paint facility comprising facility and process layouts, overview of paint facilities and equipments lists;
wherein the central computer is interactive with computer-implemented systems (1) through (5) to provide for the management of a vehicle painting operation of a vehicle assembly plant by personal.

### BRIEF DESCRIPTION OF THE FIGURES

FIG. 1 shows an overall process flow chart of a computer implemented coating system.

FIG. 2 shows materials management process flow chart.

FIG. 3 shows E-Coat system process flow chart.

FIG. 4 shows topcoat system process flow chart.

FIG. 5 shows additional elements process flow chart.

### DETAILED DESCRIPTION OF THE INVENTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

All patents, patent applications and publications referred to herein are incorporated by reference in their entirety.

A typical vehicle body (auto or truck) or part thereof is produced from a steel sheet or a plastic or a composite substrate. For example, the fenders may be of plastic or a composite and the main portion of the body of steel. If steel is used, it is first treated in a bath, typically a phosphate bath that contains an inorganic rust-proofing compound, such as, zinc or iron phosphate and then a primer coating is applied generally by E-Coat (electrodeposition) by passing the vehicle body through an electrocoating tank. Typically, these primers are epoxy-modified resins cross linked with a polyisocyanate and are applied by a cathodic electrodeposition process and baked in an oven. The vehicle body is then passed through top coating system that applies a primer coating, a base coating that contains pigment to provide color to the resulting finished paint and a clear coating is applied and provides a glossy in depth appearance to the finish on the automobile or truck body and has good gloss and distinctness of image. Also, the clear finish also provides a protective finish that is durable and resistant to scratching, marring and chipping and also provides resistance to weathering, in particular, to U.V. degradation and photo-oxidation.

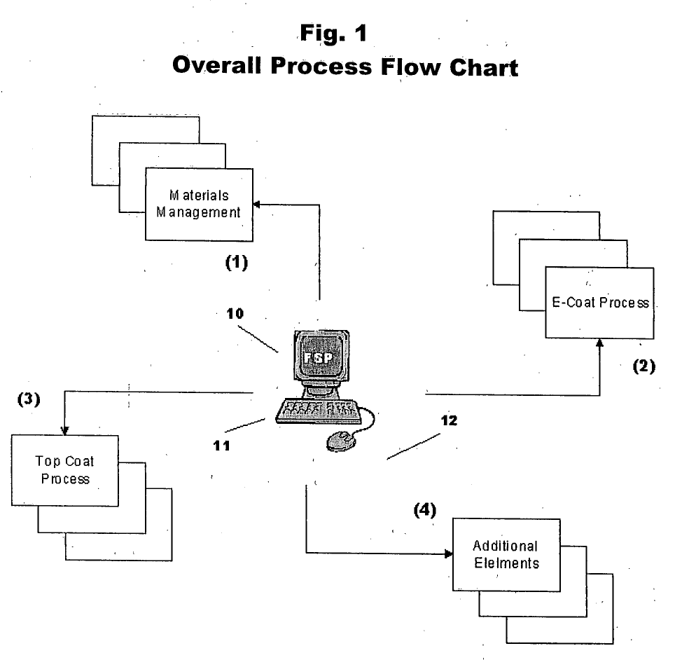

FIG. 1 shows an overall process flow chart of a computer implemented coating system. A central computer (10) is linked to the material management system (1), the E-Coat process system (2), the Top Coat Process (3) and the Additional Elements (4) required for a vehicle coating process. The central computer (10) with a conventional keyboard (11) and mouse (12), typically, a computer having 18.5 Gigabyte memory, and 1.8 GHz hard drive, and utilizing the following operating programs: Microsoft Office, including Excel, PowerPoint, Word, iGrafx and Adobe Acrobat. The central computer (10) is linked to the computer implemented materials management system (1) that continuously monitors the coating materials supplied to the paint applications systems, continuously monitors the coating of vehicles or parts thereof, and continuously monitors the circulation systems of the paint applications systems. Optionally, the materials management system monitors and reports environmental matters, inventory of coating materials in the plant and provides for the control of inventory, provides a feed back system to suppliers of coating materials needed for the operation of the plant and the quality of coating materials. The materials management system also optionally provides a method for calculating per unit costs of vehicles painted and provides the manufacturer with such costs and monitors the quality of the finished painted vehicles and feeds back variations into the calculation of per unit costs.

The central computer (10) also is linked to the computer implemented E-Coat Process (2) (electrocoating process) which monitors the operation of the electrocoating tank, the associated deionized water system, the ultrafiltration system, the anolyte system and the rinse system and monitors the baking oven for the electrocoated vehicle bodies.

The central computer (10) is linked to the computer implemented system for monitoring the top coating of vehicles after being electrocoated which comprises monitoring all aspects of primer coating, base coat application and clear top coat application. The feeding of primer during application, the circulation primer and the primer baking ovens are monitored by the system and accessible to the central computer (10) so that plant personnel can monitor and modify the primer application process when needed. Similarly, the pigmented top coat application and clear coat application process are monitored and adjusted when required.

The central computer (10) is also linked to a computer implemented system that provide additional elements for the management of the vehicle painting operation, such as, safety items, like safety clothing and equipment, protective equipment, safety programs for workers, material data sheets for materials used in the painting operation. Additionally, the system can provide training items, such as field guides, tracking of employee training, an employee training matrix, employee operational procedures, supplier and customer contacts, quality policies and guidelines, facility and process layouts, overviews of paint facilities and equipment list.

The unique advantages of the novel system of this invention are that there is a central location for the complete management of all aspects of the vehicle painting operation of a vehicle assembly plant. The system provides for the constant monitoring of the entire vehicle painting operation and provides for documentation on a daily, weekly, monthly and yearly basis of all of the painting operations. It provides for work sheets that are used by operators to run the painting operations and lays out the needs of where, when, how and who for all operating parameters of vehicle painting operations. These work sheets are laminated and placed in the assembly plant for daily use by operators. The system creates data bases that can be used, for example, to monitor paint quality, application parameters, vehicle defects, solutions to correct defects or corrections to operating parameters used, for example, in the E-Coat process or top coat spraying processes or baking procedures. The system provides plant management an overview of the vehicle painting operations and is an indispensable aid in effectively running the painting operations of a vehicle assembly plant.

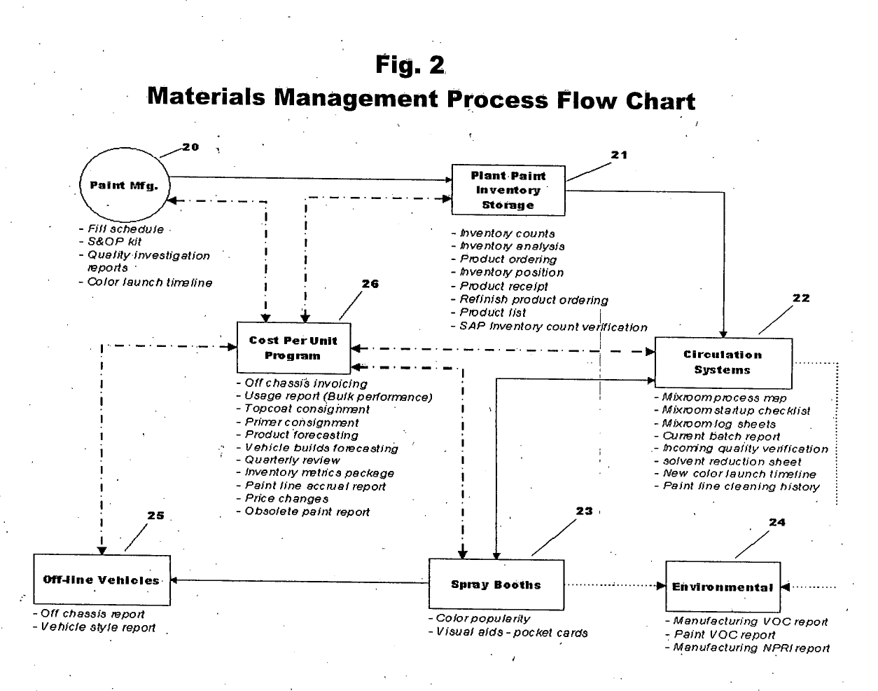

FIG. 2 shows the materials management process flow chart. Coating materials, such as, paints, solvents and paint related products are sent from the paint manufacturing facility (20) to the vehicle assembly plant and placed in the plant paint inventory storage (21) for use in the painting operations of the plant. The computer implemented system has a complete list of products used in the plant, tracks the inventory of paint products received from the paint manufacturer, provides an analysis of the inventory, such as, gallons of primer, pigmented base coat, clear top coat, provides an inventory position for each of the items and reorders items as they are used in the manufacturing process. The system also provides for order of refinish product as they are used in the plant. An Annual verification of all paint inventory on-site is reconciled with SAP inventory records (Systems Analysts and Program).

The circulation system (22) shown in FIG. 2 is linked to the plant paint inventory storage for paint and other materials, such as; solvents are fed into the circulation system connected to the spray booths (23). The computer implemented circulation system provides mix room process maps showing the entire mixing process and equipment and start-up check lists used by operators in the operation of the circulation system and provides data for mix room log sheets, current batch reports, solvent reduction sheets to bring paints to proper viscosity. Reports are filled out by operators to track the paints utilized in the plant. The incoming quality of paint and related products is monitored, checked against manufacturers standards and recorded. In the event there is a new color to be introduced, a timetable is provided of various tasks that must be accomplished before a new color is launched. Data is also provided concerning paint line cleaning history.

In the spray booths (23), vehicles are coated and the color popularity for the vehicles being sprayed is recorded and coordinated with the remainder of the vehicle manufacturing operation. Laminated Visual Aids computer generated pocket color cards are provided to paint facility personnel to check the color of the vehicle as painted.

Data on solvent usage from the spray booth (23) and from the circulation system (22) are fed to the environmental monitoring site from which reports are produced on VOC usage for the paint manufacturer, the vehicle manufacturer and a NPRI usage report is generated that is a year-end summary of vehicles painted and the amount of paint and VOC used. These reports are used to keep the plant operation within VOC guidelines.

The spray booths (23) are linked to the off-line vehicles section (25) where an off chassis report is generated that provides the number of cars painted per color and provides a vehicle style report which details the style of vehicle painted, e.g., 2 door sedan, 4 door sedan, mini-van, truck and if single color or multi-tone color, such as, a two tone color.

The cost per unit program (26) receives data from the paint manufacturer (20), plant paint inventory storage (21), circulation system (22), spray booths (23) and off-line vehicles (25) and calculates the cost per unit (vehicle) painted and provides this cost information to the vehicle manufacturer and the paint manufacturer. Generally, the paint supplier is required by the vehicle manufacturer to stay with in given cost guidelines. Also, the cost per unit program feeds information back to the paint manufacturer (20), the plant paint inventory storage (21), circulation system (22), the spray booths (23) and off-line vehicles (25) for various aspects of the operations of these sites. The cost per unit program additionally provides for off chassis invoicing, for verification of proper payment to paint manufacturer, paint usage reports (bulk usage performance), topcoat consignment, primer consignment which is a further inventory reconciliation, provides for forecasting of paint products and vehicle builds, a quarterly review of the paint operation is provided, inventory metrics package which includes inventory days supply and forecast accuracy, a paint line accrual report is generated, price changes of paints and related products are incorporated and an obsolete paint report generated.

With the information provide to the paint manufacturer (20) by the price per unit program (26), the paint manufacturer is able to manufacture paint and the correct colors at the desired times and creates a fill schedule. For new colors, a color launch time line is created to allow for timely delivery of paints. Quality investigation reports based on information fed back from the vehicle manufacturer are generated. Long term forecasting for paint manufacture is generated by an S&OP (Sales and Operations Planning) kit.

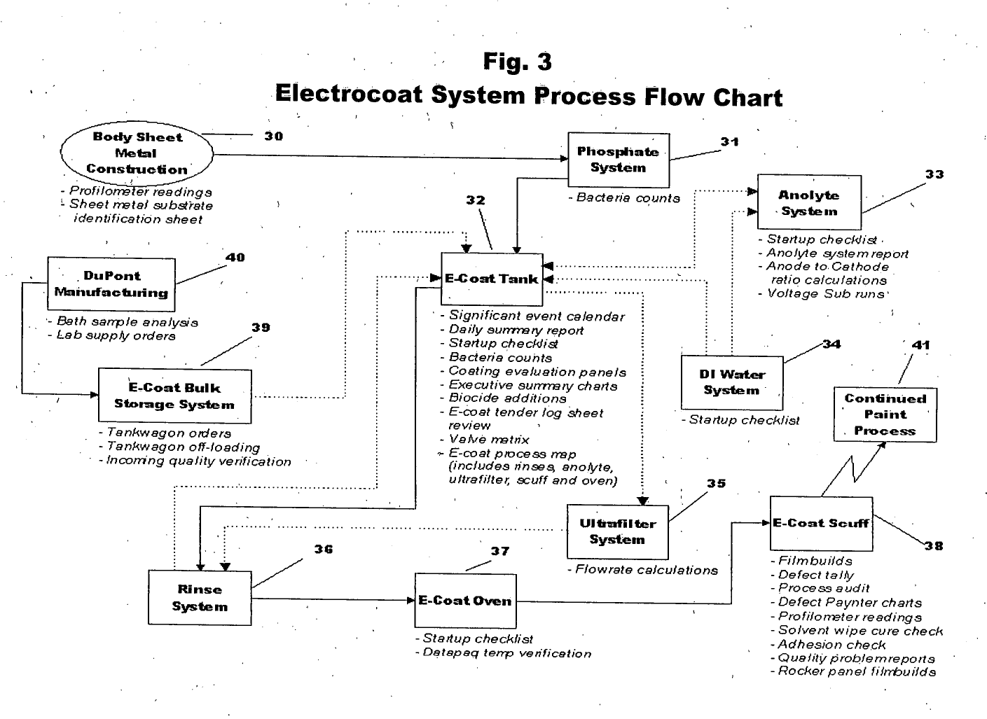

FIG. 3 shows the E-Coat (electrocoat) systems process flow chart. The system is computer implemented. The body sheet material construction (30) is monitored and tracked prior to the vehicle body entering into the electrocoating system. In particular, the surface smoothness/roughness properties are measured with a profilometer and the type of sheet material being electrocoated, such as, cold rolled steel or hot dip galvanized steel and the vehicle body part, such as, the roof, right door, left door, truck lid and hood are recorded.

The vehicle body is passed through a phosphate bath and optionally, the phosphate system (31) is monitored for bacteria count and when the count becomes too high, biocide can be added to the bath to control the bacteria.

The vehicle body is passed to the E-Coat (electrocoating) tank (32) wherein the coating is cathodically deposited on the vehicle body. The computer-implemented system monitors the bath and operators record operation parameters and create a daily routine of events and daily summary reports. Events out of the ordinary are noted and recorded in a significant events calendar. A start up checklist is developed and provided to the bath operators through the computer-implemented system. Bacteria counts of the bath are recorded and any addition of biocides to reduce bacteria are recorded. E-Coat tender log sheets are created wherein operators log in detailed parameters of the electrocoating process, typically on an hourly basis and match these parameters to the overall control plan of the vehicle manufacturer. Coated test panels are evaluated and data recorded and executive summary charts are prepared from this data and reviewed by the vehicle manufacturer and the paint supplier. A valve matrix is prepared for the operators showing the locations of the valves used in the process and the position the valves should be in during the process and are typically color coded, for example, green for open, red for closed, white for partially open. Through the computer implemented system an entire E Coat process map is developed which includes the rinses, anolyte, and ultrafiltration systems, oven and E-coat scuff in which physical properties of the electrodeposited film, process parameters and other related parameters are shown.

The anolyte system (33) is linked through the computer implemented system to the E-Coat tank and designates the amount of acid to be removed from the tank during operation and a report is generated by the operators of the system. A start up checklist is developed through the computer implemented system. Anode to cathode ratios are calculated to determine the anode surface area to surface area of vehicle being coated to determine if the tank is running within specifications. A voltage sub run is made that measures the voltage inside of the E Coat tank and determines if it is sufficient to provide acceptable results.

The DI (deionized) water system (34) is linked through the computer-implemented system to the E-Coat tank (32) and the Anolyte System (33) and the conductivity of the water is monitored to determine if it is within specifications. The computer-implemented system provides a startup checklist for the operation of the DI water system.

The Ultrafiltration system (35) is linked through the computer implemented system to the Rinse system (36) and to the E-Coat tank (32). Flow rates for the ultrafiltrate to the Rinse system (36) are calculated and adjustments made by operators to ensure that there is an adequate flow rate to the Rinse system (36).

The Rinse system (36) is linked to the Ultrafiltration system (35) and to the E-Coat tank (32). Vehicle bodies or parts when exiting the E-Coat tank (32) pass through the Rinse system (36) where excess electrocoating composition is rinsed off the body or part and then the body or part is passed into the E-Coat oven (37) to be baked to form a cured coating. Biocide can be added in the Rinse system (36) and the rinse flows back to the E-Coat tank (32). A start up check list is generated through the computer implemented system and is used by the operator and a nozzle matrix is created that provide the status of each of the nozzles used in the Rinse system (36) and notifies the operator of the location of the nozzle and if it requires adjustment, is plugged, needs replacement or is in acceptable operating order.

The coated vehicle body or part is passed into the E-Coat oven (37) and baked for a set period of time to cure the coating. A checklist is generated through the computer-implemented system and utilized by the operator.

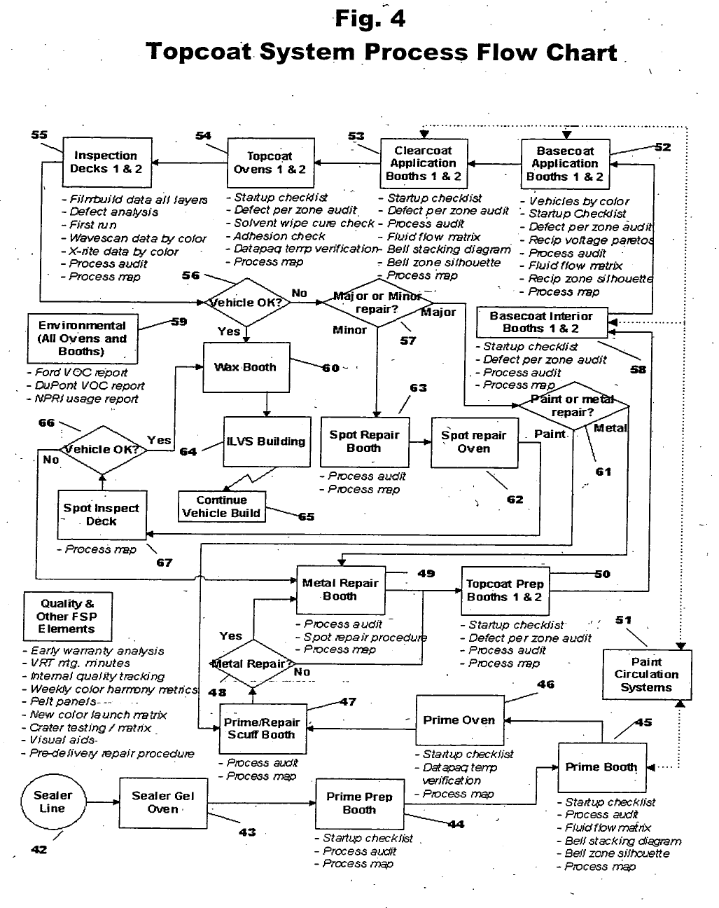

In E-Coat scuff (32), the electrodeposited coating or paint is physically scuffed to provide an acceptable surface for the additional coating operation. The film build of the electrodeposited coating is checked by a non destructive measuring system using an elcometer 300. Defects in coated vehicle bodies and parts are determined and logged in on a chart and is available to operators and plant management. A monthly audit of the process is performed and made available to the vehicle manufacturer and to the paint manufacturer. Defect paint charts (Paynter charts) are created to show defects over a period of time and to determine if there has been an improvement in the number of defects or if defects have continued or gotten worse over time. The surface of the electrocoated vehicle bodies and/or parts is measured with a profilometer and a comparison can be made to original surface before electrocoating. To measure over bake or under bake conditions of the electrodeposited paint, a solvent wipe is used. Adhesion of the electrodeposited paint is determined using a crosshatch cut of surface and tape to perform a pull test in cut area. Through the computer implemented system quality problem reports are prepared for review by manufacturing plant management and paint supplier management and aids in the resolution of problems resulting in the electrocoating process. The electrocoated vehicle body or part then is continued through the painting process (41) shown in detail in FIG. 4.

In Paint Manufacturing (40) of electrocoating compositions bath samples from the E-Coat tank (32) are checked by the manufacturer to determine if the electrocoating going to the tank is within specifications and this is linked via the computer implemented system through E-Coat Bulk Storage System (39) to the E-Coat tank (32). In Paint Manufacturing (40), the maker of the electrocoating composition, provides tank wagon orders to the vehicle manufacturing plant and is kept in the bulk storage system of the plant. Tank wagon off loading is monitored to ensure it is done properly and off loading data is recorded. Incoming quality of the electrocoating composition is checked to determine if it is within specifications and to verify the manufacturers specifications.

The vehicle body or part that has been coated according to the E-Coat procedure shown in FIG. 3 is then top coated as provided in FIG. 4. FIG. 4 shows a top coat system process flow chart in which a computer implemented system monitors the application on a vehicle body or a part of primer coating, baking of primer coating, repair of defective primer coating, preparation for the application of additional top coating, base coating application, clear coating application, baking of base coating and clear coating, repair of defective top coating and quality control of coating.

Typically, a Sealer Line (42) that applies a sealer coat to the coated vehicle or part is passed through a Sealer Gel Oven (43), which is both optionally monitored by the computer-implemented system. The sealer coated vehicle body or part is passed into a Prime (primer) Prep (preparation) Booth (44) wherein the surface of the coating is lightly sanded. A start up checklist is developed through the computer-implemented system and the process is audited and process maps are generated. The vehicle body or part is then passed into the Prime (primer) Booth (45) wherein primer is spray applied. A start up checklist is developed through the computer-implemented system and the process is audited. A fluid flow matrix is developed for the spray bells used in the booth. A spray bell-stacking diagram is created which shows the distance of the bell to the piece being sprayed which should basically be the same for each bell. A bell spray zone silhouette is developed which is a visual aid to show the spray zone for the operators and a process map is also developed and updated with any changes in the spraying process.

The primer coated vehicle body or part is then passed into the Prime (primer) Oven (46) wherein the oven temperature is monitored, data on the temperature of the metal is verified and recorded, the length of time the body or part is in the oven is recorded. A start up checklist is developed by the computer-implemented system and a process map is generated.

The vehicle body or part is then sent to the Prime/Repair Scuff Booth (47) and then a determination is made at decision point (48) if the vehicle body or part is in need of repair or does not need repair. There is a process audit made and a process map is prepared via the computer implemented system. If no repair is needed, the vehicle or part is then sent to the Topcoat Prep (preparation) Booth (50). If a repair is required for the vehicle body or part that has damage, it is sent to the Metal Repair Booth (49) wherein there is a process audit made and a spot repair procedure is used to make the repair and a process map is developed for the repair of defects and then the vehicle body or part is sent to the Top coat Prep Booth (50).

In the Top coat Prep Booth (50) any dirt on the vehicle body or part is blown off. A defect per zone audit is conducted wherein there is an analysis of any dirt present in any of the coating layers. A process audit is conducted and recorded and a process map is developed.

The vehicle body or part is then moved to the Base coat Interior Coat Booths 1 & 2 (58) wherein the interior of the body or part is sprayed by robots with a base coating composition. Defects per zone are determined and a process audit is done and recorded and a process map is generated via the computer-implemented system.

The vehicle body or part is moved to Base coat Application Booths 1 & 2 (52) wherein the exterior colored base coat is applied. Vehicle color is scheduled and color time and date recorded. A start up checklist is generated via the computer-implemented system. Defects per zone audit is conducted and maintenance of voltage used for spray gun is recorded and a process audit is done that monitors the spray process to determine if spray procedures were followed. A fluid flow matrix is developed for the spray guns used in the process. Air pressure used for the spray guns is monitored. Reciprocator Zone Silhouette is provided that is a visual aid showing spray zone of portions of a vehicle body, such as, a fender, a front door, a rear door and other parts of the vehicle body. Each gun or bell has a different spray silhouette. A process map is developed for this portion of the process.

The vehicle body or part then is sent to the Clear coat Application Booths 1 & 2 (53) wherein clear coat is spray applied typically by both a manual and an automated spraying process. Start up checklist is developed via the computer-implemented system and used by the operator. Defects per zone in the process are recorded and a process audit is done and data recorded for use in the computer-implemented system. A fluid flow matrix is developed for each of the spray guns and used by operators controlling the process. As with the Prime Booth (45), a bell stacking diagram, a bell zone silhouette and a process map are prepared for use by the operators for the clear coat application.

The vehicle body or part is sent to Top coat Ovens 1 & 2 (54). A start up check list and process map are developed via the computer-implemented system and used by the operator. Data is recorded on metal temperature to verify baking conditions in the process. After baking, defects per zone are audited and data recorded, the cure of the coating is checked with a solvent wipe test procedure and the adhesion of the coating is checked and data recorded. The vehicle or part then is sent to the Inspection Decks 1 & 2 (55) wherein film build is determined by non-destructive ultrasonic beam test, which provides for the determination of the thickness of each layer of coating applied and the data is recorded. Defects are analyzed and recorded. The first run (percentage yield sent to trim based on total vehicles processed) is graphed. A wave scan device is used to measure DOI (distinctness of image), gloss and orange peel and data is recorded. Color is measured by an X-Rite instrument and L, a and b values measured and the delta determined from vehicle manufacture standards is determined and recorded. The process is audited and data recorded and a process map is developed and used by the operator.

A determination is made whether or not the vehicle or part is acceptable (decision point position 56). If it is acceptable, it proceeds to the wax booth (60) where an interior door wax is applied along with sound deadener sealer on the underbody and then to the ILVS (in line vehicle scheduling) building and then continues in the vehicle building process (65) where it is scheduled to be assembled with other body parts of the same color. These body parts are the “just in time” delivery procedure used by a typical vehicle manufacture plant.

In the event the vehicle or part is not acceptable, there is a decision point (position 57) in which a determination is made for a minor or major repair. If the repair is minor, the vehicle or part is sent to the Spot Repair Booth (63) where a spot repair refinish paint is applied and the process is audited and a process map created and then the vehicle or part is sent to the Spot Repair Oven (62) where a slightly elevated temperature is used to dry and cure the spot repair finish and then the vehicle or part is sent to Spot Inspection Deck (67) where it is inspected and a process map created via the computer implemented system is utilized by an operator. Decision point (66) determines if the vehicle is accepted and if it is it proceeds to the wax booth (60), ILVS Building (64) and Continue of the vehicle build (65) as described above. If is not acceptable, it proceeds to the Metal Repair Booth (49), then to the Top coat Prep Booth 1 and 2 (50) and then through the entire base coat, clear coat and inspection process (58), (52), (53), (54) and (55) as described above.

Returning back to decision point (56) and (57), if the vehicle or part is determined to require major repair, it is sent to decision point (61) where a determination is made if a paint repair or a metal repair is required to be made. If a paint repair is to be made the vehicle or part is sent to the Prime/Repair Scuff Booth (47) and then to the Top coat Prep Booth 1 and 2 (50) and then through the entire base coat, clear coat and inspection process (58), (52), (53), (54) and (55) as described above. If a repair to the metal is required, it is sent to the Metal Repair Booth (49), then to the Top coat Prep Booth (50) and then through the entire base coat, clear coat and inspection process (58), (52), (53), (54) and (55) as described above.

Environmental Reports (59) for all ovens and booths are generated to report VOC usage to the paint supplier and to the vehicle manufacture and a NPRI usage report is generated using the computer implemented system.

In the operation of the top coating system quality, and other elements (41) are utilized and implemented via the computer system. An early warranty analysis is determined in which the number of defects and when in the process these defects occurred are used and is provided to the vehicle manufacturer. Meetings of a variable reduction team for the reduction of defects utilizing the early warranty analysis are conducted utilizing early warranty analysis information. Weekly color harmony matrix is developed to determine if parts that are attached to the vehicle body that are painted at a different location match the color of the vehicle body. Pelt panels are created for use in calibration of equipment that measures film build and sent to equipment supplier for any software modifications that may be required. New color launch matrices are developed for use by paint manufacturer and vehicle manufacturer. Crater testing is done and documented and in the event of process material change, these products are tested prior to implementation and recorded and a matrix is developed. Visual aids are developed for operator use, such as, color cards, paint kitchen color cards and valve identification visual aids. Pre-delivery off line repair procedures are developed for refinishing defects in vehicles and system developed to determine if repair procedures have been followed.

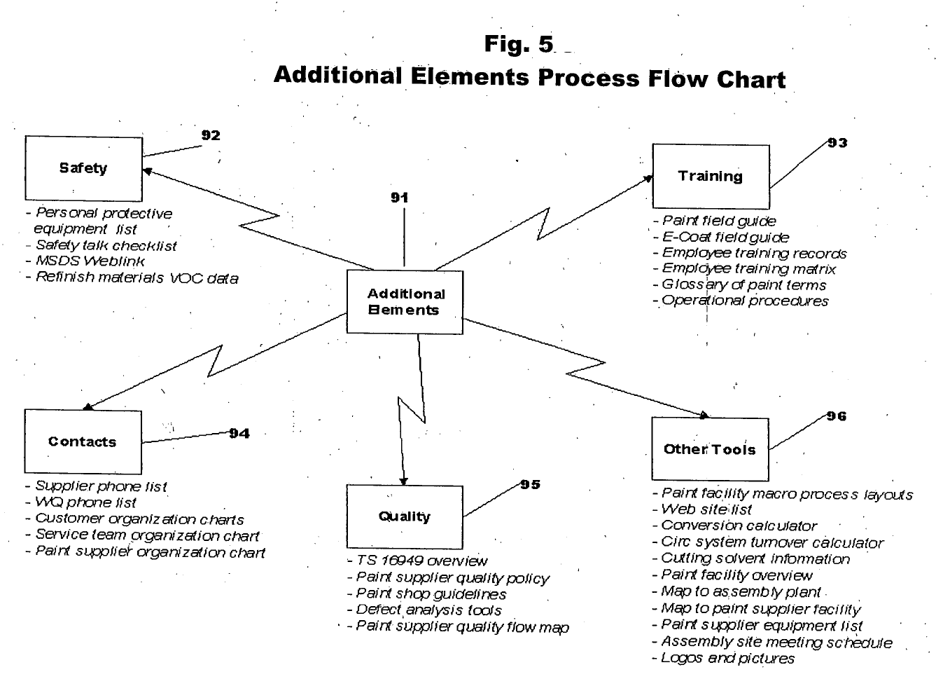

FIG. 5 shows an additional elements process flow chart that is utilized with the computer implemented coatings system. Additional elements (91) are incorporated into the central computer (10) shown in FIG. (1). Safety (92) is one of the additional elements that incorporate personal protective items, like safety glasses, protective clothing and other protective items. Check lists for safety talks related to the coating process are developed. MSDS web link is made available for easy access to the properties of materials used in the painting process and a VOC refinish materials data information is made available via the computer implemented system.

Training (93) is another item and provides paint field guides, E-Coat field guides, keeps employee training records, develops a training matrix for employees, and a glossary of paint terms and operational procedures are provided via the computer implemented system.

Contacts (94) are provided, such as, a supplier phone list, vehicle manufacturer's phone list, customer organization charts, service team organization charts and paint supplier organization charts.

Quality (95) is provided that shows a TS 16949 overview, which is an automotive industry, standard for quality reporting, the paint supplier's quality policy, the paint shop guidelines, defect analysis tools and paint supplier's quality flow map.

Other Tools (96) are also provided, such as, paint facility macro process layout, web site list, conversion calculator, circulation system turnover calculator, information used to cut coating composition with solvents, paint facility overview, map to vehicle assembly plant, map to paint supplier facility, paint supplier equipment list, assembly site meeting schedule and logos and pictures that are in use.

The aforementioned elements are all useful in the operation of the coating operation of a vehicle assembly plant and are incorporated into the computer-implemented system and readily accessible to plant personnel, supplier personnel and management people to ensure trouble free and continued operation of the painting operation.

What is claimed is:

1. A computer implemented system for the management of a vehicle painting operation of a vehicle assembly plant, which comprises
(1) a central computer;
(2) computer implemented materials management system linked to the central computer that comprises for the continuous monitoring of coating materials supplied to paint applications systems for the coating of vehicles or parts thereof or both, continuous monitoring of circulation systems for the paint applications systems, and monitoring of paint application systems;
(3) a computer implemented system for monitoring the electrocoating of vehicles linked to the central computer that comprises monitoring the electrocoating tank, the associated deionized water system, the ultrafiltration system, the anolyte system and the rinse system, and the electrocoat baking oven;
(4) a computer implemented system for monitoring the top coating of vehicles after being electrocoated linked to the central computer that comprises monitoring all of the aspects of the primer application, the base coat application and the clear top coat application; and
(5) a computer implemented system for providing additional elements for the management of the vehicle painting operation, which comprises safety items and training items.;
wherein the central computer being interactive with the computer implemented systems (1) through (5) provides for the management of a vehicle painting operation of a vehicle assembly plant by personnel.

2. The computer implemented system of claim 1 in which the materials management system additionally comprises monitoring and reporting of environmental matters.

3. The computer implemented system of claim 1 in which the materials management system additionally comprises monitoring inventory control of coating materials in assembly plant and a feed back system to supplier of coating materials.

4. The computer implemented system of claim 3 in which the materials management system additionally comprises monitoring quality of coating materials supplied to the assembly plant.

5. The computer implemented system of claim 1 in which the materials management system additionally comprises a method for calculating per unit costs of vehicles painted.

6. The computer implemented system of claim 5 in which the materials management system additionally comprises monitoring quality of finish of painted vehicles with a feed back system to calculating per unit costs of vehicles painted.

7. The computer implemented system of claim 1 in which the top coating of vehicles additionally comprises continuous monitoring of the feeding of primer during the primer application, circulation of primer in the primer application system and of the primer ovens used to cure the primer after application to a vehicle.

8. The computer implemented system of claim 7 in which the top coating of vehicles additionally comprises continuous monitoring of the feeding of topcoat during topcoat application and circulation of topcoat in the topcoat application system.

9. The computer implemented system of claim 8 in which the top coating of vehicles additionally comprises continuous monitoring of the feeding of clear coat during clear coat application and circulation of clear coat in the clear coat application system and of the topcoat ovens used to cure the basecoat/clearcoat after application to a vehicle.

10. The computer implemented system of claim 1 in which the additional elements additionally comprise safety elements comprising protective equipment, safety programs for workers, material data sheets for materials used in painting operation.

11. The computer implemented system of claim 1 in which the additional elements are comprised of training items, field guides, tracking of employee training, employee training matrix and employee operational procedures.

12. The computer implemented system of claim 1 in which the additional elements are comprised of supplier and customer contacts, quality policies and guidelines, facility and process layouts, overview of paint facilities and equipments lists.

13. A computer implemented system for the management of the electrocoating of a vehicle painting operation of a vehicle assembly plant, which comprises
(1) a central computer;
(2) a computer implemented system linked to the central computer that comprises monitoring the electrocoating tank as vehicles are being electrocoated, monitoring replenishment of the electrocoating composition, monitoring the associated deionized water system, the ultrafiltration system, the anolyte system to ensure proper balance components of the electrocoating composition and monitoring the rinse system for rinsing electrocoated vehicle bodies, and the electrocoat baking oven and monitoring and providing reports of quality of electrocoated vehicles;
wherein the central computer being interactive with the computer implemented system for the electrocoating of vehicles provides for the management of the electrocoating painting operation of a vehicle assembly plant.

14. The computer implemented system of claim 13 in which the computer implemented system additionally comprises monitoring of the electrocoating tank by generation of a significant events calendar, daily summary reports generated by operators comprising solids of electrocoating composition in the tank, pH of the composition and conductivity of the composition, generating a startup check list, monitoring of bacteria count in the tank and recording of biocide additions to the tank, recording data on coating evaluation of panel coated, generation of executive summary reports, providing a tender log sheet review of tank operation, developing a valve matrix for tank operation and developing an electrocoating process map for tank operations.

15. The computer implemented system of claim 14 in which the computer implemented system additionally comprises for the monitoring of the anolyte system in relation to the electrocoating tank comprising generation of anolyte systems report, start up check list, anode to cathode ratio calculations and voltage during electrocoating vehicles, monitoring the deionized water system, generating a start up check list, monitoring the ultrafiltration system, calculating flow rates, monitoring the rinse system comprising generating start up check list, recording biocide additions and developing a spray nozzle matrix showing location and operation of spray nozzles and monitoring the electrocoating oven comprising generating a start up check list and monitoring temperature data of oven operation.

16. The computer implemented system of claim 15 in which the computer implemented system additionally comprises monitoring of quality of electrocoated vehicles which comprises measuring and recording thickness of film applied during electrocoating, recording defects of electrocoated films on vehicle bodies over a period of time, creating a process audit over a set period of time and a defect paint chart tracking defects over a period of time and comparing defects, monitoring and recording surface roughness of electrocoated vehicle bodies, monitoring and recording under bake or over bake conditions using solvent to determine adhesion and generating a quality problem report.

17. The computer implemented system of claim 13 in which the computer implemented system additionally comprises monitoring and recording of initial surface roughness of vehicle substrates and identifying substrates to be electrocoated, monitoring of electrocoating baths and providing information to electrocoating paint manufacturer, placing orders to electrocoating paint manufacturer in relation to usage in electrocoating process, monitoring of loading of electrocoating composition from paint manufacturer and monitoring and recording quality of electrocoating composition from paint manufacturer.

18. A computer implemented system for the management of the top coating of a vehicle painting operation of a vehicle assembly plant, which comprises
(1) a central computer;
(2) a computer implemented system linked to the central computer that comprises monitoring the primer application to a vehicle body or part, monitoring the primer oven operation and primer circulation system, monitoring the base coat paint application of primer coated vehicle body or part, monitoring the clear coat application to the base coated vehicle body or part thereof, monitoring the top coat baking oven and monitoring defects resulting from the primer and base coating and clear coating of vehicle body or part thereof;
wherein the central computer being interactive with the computer implemented system for the top coating of vehicles provides for the management of the topcoat painting operation of a vehicle assembly plant.

19. The computer implemented system of claim 18 in which the computer implemented system additionally comprises the following components monitored by the computer implemented system: a primer preparation booth, a primer repair booth for repairing defects in the primer coating on the vehicle body or part, a top-coat preparation booth for preparing the primer coated vehicle body or part, a base coating both for coating the interior of a vehicle body or part, a repair check point for determining minor or major repairs of a primer coated base coated clear coated vehicle or part that has a defect, a spot repair booth for repairing a defective vehicle body or part, a quality control monitoring and reporting area.

20. The computer implemented system of claim 19 in which the computer implemented system additionally comprises preparing check lists, process audits, defects audit for the primer preparation booth, the primer booth, the base coat application booth and the clear coat application booth, along with pre-delivery booth in the final assembly area.
